(19) United States
(12) Patent Application Publication
(10) Pub. No.: US 2014/0034747 A1
(43) Pub. Date: Feb. 6, 2014

(54) Method For Detecting A Nozzle Chamber Pressure In An Injector And Injection System

(71) Applicants: Hans-Jörg Wiehoff, Regensburg (DE); Steffen Lehner, Eichstatt (DE); Vera Balk, Mintraching (DE)

(72) Inventors: Hans-Jörg Wiehoff, Regensburg (DE); Steffen Lehner, Eichstatt (DE); Vera Balk, Mintraching (DE)

(21) Appl. No.: 14/111,623

(22) PCT Filed: Mar. 19, 2012
(86) PCT No.: PCT/EP12/54799

§ 371 Date: Oct. 14, 2013

(30) Foreign Application Priority Data
Apr. 14, 2011 (DE) 10 2011 007 393.0

(51) Int. Cl. F02M 57/00; G01L 9/08; G01L 9/12; F02M 69/00

(52) U.S. Cl. CPC F02M 57/005; F02M 69/00; G01L 9/08; G01L 9/12
USPC 239/5; 239/71; 73/753

(57) ABSTRACT

A method is disclosed for detecting a nozzle chamber pressure in an injector that includes a closure element for opening and closing an injection opening, at least one actuator which directly actuates the closure element, and at least one sensor for measuring a state, which is dependent on the nozzle chamber pressure, of the closure element, wherein at least one measurement variable which is dependent on the state is detected by means of the sensor, and wherein a deviation of the measurement value from a predefined value is determined. An injection system for carrying out such method is also disclosed.

### CROSS-REFERENCE TO RELATED APPLICATIONS

This application is a U.S. National Stage application of International Application No. PCT/EP2012/054799 filed Mar. 19, 2012, which designates the United States of America, and claims priority to DE Application No. 10 2011 007 393.0 filed Apr. 14, 2011, the contents of which are hereby incorporated by reference in their entirety.

### TECHNICAL FIELD

This disclosure relates to a method for detecting a nozzle chamber pressure in an injector and to an injection system for carrying out said method.

### BACKGROUND

Injection systems by means of which fuel is injected into a combustion chamber of an internal combustion engine have long been known. Injection systems of this kind comprise at least one injector and at least one open- and closed-loop control unit connected to the injector for controlling an injection process. In this case, the injector comprises a nozzle chamber, from which fuel can be injected into the combustion chamber through an injection opening. The opening and closing of the injection opening is performed by means of a closure element, which can be actuated, i.e. moved, by an actuator. The nozzle chamber can be supplied with fuel by means of a high-pressure pump via a high-pressure reservoir and a fuel line.

The aim of modern injection systems is to ensure operation with minimum emissions, low consumption and low stress and to ensure high efficiency during combustion. A mixture formation process and combustion are decisively influenced by a time characteristic of an injection rate. For optimum operation of the engine, an injection quantity, an injection duration and an injection point must be controlled as accurately as possible.

However, there are number of disturbance variables which interfere with accurate control of this kind. One example that may be mentioned is the fuel inlet pressure at the injector, which can be subject to considerable fluctuations. Such fluctuations are produced, for example, by pressure fluctuations in the high-pressure reservoir and by the injection process itself and have a disadvantageous effect on control of the injection quantity. The fluctuations can occur in a given operating period of one and the same injector, resulting in irregular injection in this injector. In the case of internal combustion engines with a plurality of injectors, the fluctuations in the various injectors can furthermore differ in each case, creating an additional difficulty for accurate control of the injection quantities in the various injectors. Such differences between the various injectors may be due to differences in the arrangement of the fuel lines, for example. However, they can also arise in the course of time due to differences in the wear in each of the injectors. For optimum operation of the internal combustion engine, it is therefore necessary to characterize the disturbance variables that interfere with accurate control of injection parameters as accurately as possible.

### SUMMARY

On embodiment provides a method for detecting a nozzle chamber pressure in an injector, which comprises a closure element for opening and closing an injection opening, at least one actuator, which directly actuates the closure element, and at least one sensor for measuring a state, which is dependent on the nozzle chamber pressure, of the closure element, wherein at least one measured value of at least one measured variable, which is dependent on the state, is detected by means of the sensor, and wherein a deviation of the measured value from a predefined value is determined.

In a further embodiment, the actuator and the sensor form a structural unit in the form of a piezo actuator, wherein the piezo actuator is used as an actuator or as a sensor, depending on the operating mode.

In a further embodiment, the measured variable comprises one or more of the following variables and/or a variable derived from one or more of the following variables: an electric voltage applied to the sensor, an electric charge which is stored in the sensor and/or has flowed to the sensor, an electric current which is flowing through the sensor and/or has flowed to the sensor, a capacitance of the sensor, and energy which is stored in the sensor and/or has flowed to the sensor or has flowed from the sensor.

In a further embodiment, an output stage of the sensor is operated with high impedance for the purpose of detecting the measured value.

In a further embodiment, the measured value is detected during a charging phase and/or during a holding phase and/or during a discharge phase of the sensor.

In a further embodiment, the state of the closure element comprises a position and/or a speed and/or an acceleration and/or a force transmitted to the sensor by the closure element.

In a further embodiment, an angular position of a piston of a cylinder associated with the injector is additionally detected when determining the deviation.

In a further embodiment, the predefined value is given by a system pressure detected in a high-pressure reservoir or demanded by a control unit in accordance with an engine state or is given by a measured value, corresponding to the system pressure, of the measured variable.

In a further embodiment, a correction of an activation of the injector is performed based on the deviation of the measured value from the predefined value.

In a further embodiment, the correction comprises a change in an injection time and/or in an injection point and/or in a deflection of the closure element and/or in a time characteristic of the deflection of the closure element during an injection process.

In a further embodiment, the correction is performed in accordance with an angular position of a piston of a cylinder associated with the injector and/or in accordance with an engine state and/or with a temperature of the injector and/or with a geometry of a fuel feed to the injector.

Another embodiment provides an injection system comprising at least one injector, which comprises a closure element for opening and closing an injection opening, at least one actuator, which directly actuates the closure element, and at least one sensor for measuring a state, which is dependent on a nozzle chamber pressure, of the closure element, and comprising an open- and closed-loop control unit, wherein the injection system is set up to carry out any of the methods disclosed above for detecting a nozzle chamber pressure.

### BRIEF DESCRIPTION OF THE DRAWINGS

Example embodiments are discussed in detail below with reference to the drawings, in which:

FIG. 1 shows a schematic diagram of an injection system having an injector and having an open- and closed-loop control unit,

FIG. 2 shows a simulated time characteristic, based on the injection system in FIG. 1, of a piezo actuator voltage, of a fuel pressure ahead of a nozzle chamber, of a nozzle chamber pressure and of an injection rate,

FIG. 3 shows the piezo actuator voltage as in FIG. 2 but on an enlarged scale,

FIG. 4 shows a measured time characteristic of a line pressure immediately ahead of the nozzle chamber, of a control current and of an actuator voltage, based on the injection system in FIG. 1,

FIG. 5 shows an enlarged view of a segment of the line pressure and of the actuator voltage in FIG. 4, and

FIG. 6 shows the injection system in FIG. 1 in schematic form, wherein details of the open- and closed-loop control unit are illustrated schematically.

### DETAILED DESCRIPTION

Embodiments of the present disclosure provide a method which enables disturbance variables that interfere with accurate control of injection parameters, e.g. an injection quantity and a time characteristic of an injection rate, to be determined as accurately as possible and as specifically as possible for each of a plurality of injectors. The intention is furthermore to develop an injection system by means of which a method of this kind can be carried out.

A description is given of a method for detecting a nozzle chamber pressure in an injector, which comprises a closure element for opening and closing an injection opening, at least one actuator, which directly actuates the closure element, and at least one sensor for measuring a state, which is dependent on the nozzle chamber pressure, of the closure element, wherein at least one measured value of at least one measured variable, which is dependent on the state, is detected by means of the sensor, and wherein a deviation of the measured value from a predefined value is determined.

An injection system which is set up to carry out a method for detecting a nozzle chamber pressure in an injector comprises at least one injector, which comprises a closure element for opening and closing an injection opening, at least one actuator, which directly actuates the closure element, and at least one sensor for measuring a state, which is dependent on a nozzle chamber pressure, of the closure element, and further comprises an open- and closed-loop control unit.

The injection system is preferably of the kind used in internal combustion engines of motor vehicles. However, the method and the injection system can be applied and used in any internal combustion engine. The closure element is preferably a nozzle needle, which is set up to open and close the injection opening repeatedly and thus to control the injection of fuel into a combustion chamber. The actuator is an element for moving the closure element. An injection process is thus controlled by means of the actuator. There is direct actuation, as specified herein, of the closure element when the actuator and the closure element are in direct mechanical contact or when they are connected to one another by solid bodies, thus ensuring that a force exerted on the closure element by the actuator is transmitted to the closure element. The change in the height, width or length of the solid bodies under a maximum load during operation should be no more than one percent and preferably no more than one tenth of a percent. At the same time, there may well be a change in a direction and a magnitude of the force, e.g. due to transmission by a lever. The decisive point is that there is no hydraulic or pneumatic coupling between the actuator and the closure element. The closure element and the sensor are also preferably coupled directly in the sense described above.

By means of the method claimed here and by means of the injection system claimed here, it is possible to detect fluctuations in the nozzle chamber pressure directly in the nozzle chamber, where they have a direct effect on the injection process. Based on an accurate knowledge of said fluctuations, it is possible to modify an injection quantity, an injection duration, an injection point or other parameters relevant to the injection process in such a specific way that the fluctuations in the nozzle chamber pressure are compensated.

In one embodiment, the actuator and the sensor are comprised by at least one piezo actuator, which actuates the closure element directly. In other words, the actuator and the sensor form a structural unit in the form of a piezo actuator. Depending on the operating mode, the piezo actuator can be operated both in an actuator mode and in a sensor mode. By supplying the piezo actuator with a control voltage or a control current, the piezo actuator is operated in the actuator mode. By virtue of the inverse piezoelectric effect, it can change its length and, in the actuator mode, can bring about a change in a position of the closure element. The control voltage and the control current can be constant with respect to time or variable with respect to time. Typical values for an absolute magnitude of the control voltage are up to 1 kV, preferably up to 200 V. Typical values for an absolute magnitude of the control current are up to 20 A, preferably up to 10 A. The same piezo actuator can be operated in the sensor mode since, by virtue of the piezoelectric effect, the measured value of the measured variable which is detected by means of the piezo actuator or at the piezo actuator depends on the state of the closure element. The piezo actuator can be operated simultaneously in the actuator mode and in the sensor mode. However, it is also possible for it to be operated only in the actuator mode or only in the sensor mode respectively. Thus, there is no need for an additional sensor, and therefore the costs for materials and assembly are reduced. A length of the piezo actuator can be set with an accuracy in the nanometer range and with a time precision in the microsecond range. With such a time precision, the piezo actuator can be used to determine pressure differences in the pressure chamber of less than one bar.

In another embodiment, the measured variable comprises one or more of the following variables and/or a variable derived from one or more of the following variables:
an electric voltage applied to the sensor,
an electric charge which is stored in the sensor and/or has flowed to the sensor,
an electric current which is flowing through the sensor and/or has flowed to the sensor,
a capacitance of the sensor,
energy which is stored in the sensor and/or has flowed to the sensor or has flowed from the sensor.

In another embodiment, an output stage of the piezo actuator operated in the sensor mode is operated with high impedance for the purpose of detecting the measured value. In other words, the output stage is not short-circuited to detect the measured value, and therefore it is operated at zero current. Here, the measured value is preferably detected in an incompletely discharged state of the piezo actuator. In this way, a falling voltage across the piezo actuator is increased and precision of a measurement of the measured variable which is carried out with or at the piezo actuator is increased.

In another embodiment, the measured value is detected during a charging phase of the piezo actuator or piezo sensor or of some other sensor and/or during a holding phase of the piezo actuator and/or during a discharge phase of the piezo actuator and/or between successive injection processes. In this context, the charging phase is a time interval within which the length of the piezo actuator continuously increases.

Conversely, the discharge phase is a time interval within which the length of the piezo actuator continuously decreases. The holding phase is a time interval within which the length of the piezo actuator does not change, wherein a charge stored in the piezo actuator should assume a minimum value. The sensor or piezo actuator can thus be used in a particularly flexible manner, and measurements can be performed during any phase of an injection process and/or of a piston cycle. In this way, a maximum amount of information on a time characteristic of the nozzle chamber pressure can be collected.

In another embodiment, the state of the closure element comprises a position of the closure element and/or a speed of the closure element and/or an acceleration of the closure element and/or a force transmitted to the sensor by the closure element and/or a change with respect to time in the force transmitted by the closure element to the sensor. It is thus possible to detect the nozzle chamber pressure using that state of the closure element which ensures a maximum possible accuracy or reliability of measurement.

In another embodiment, an angular position of a piston of a cylinder associated with the injector is additionally detected when determining the deviation. In addition, it is also possible for a temperature of the injector and/or a speed of the engine and/or an injection quantity injected by the injector and/or an injection duration and/or a number of injections per piston cycle and/or a pressure in the high-pressure reservoir to be detected. The angular position determines a phase of a cyclic piston movement and defines a position of the piston in the cylinder. Through as comprehensive a knowledge as possible of these parameters, it is possible to use a dependence of the nozzle chamber pressure on these parameters for optimization of the injection process.

In another embodiment, the predefined value is given by a system pressure detected in a high-pressure reservoir and/or demanded by a control unit in accordance with an engine state. To determine the deviation, it is expedient either to convert the measured value into a pressure value or to convert the system pressure into a corresponding system measured value which has an identical physical dimension to the measured value.

In another embodiment, a correction of an activation of the injector is performed based on the deviation of the measured value from the predefined value. Here, the correction can comprise a change in an injection duration and/or in an injection point and/or in a deflection of the closure element and/or in a time characteristic of the deflection of the closure element during an injection process. The correction can also be performed in accordance with an angular position of a piston of a cylinder associated with the injector and/or in accordance with an engine speed and/or with a temperature of the injector and/or with a geometry of a fuel feed to the injector and/or with a geometry of the injector and/or with an arrangement of the high-pressure pump and/or with a pumping rate of the high-pressure pump. By taking into account as many as possible of the parameters affecting the nozzle chamber pressure and the injection process, this process can be optimized in a particularly efficient manner.

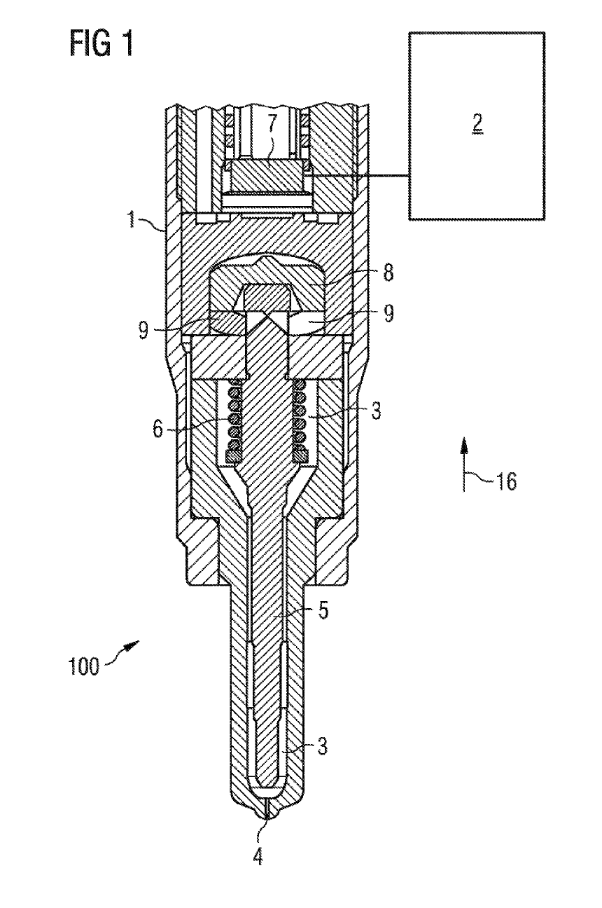

FIG. 1 shows an injection system 100, which has an injector 1 and an open- and closed-loop control unit 2. The injection system 100 is used in a diesel engine of a passenger vehicle, for example. The injector 1 is set up to inject fuel into a combustion chamber of an internal combustion engine. The injector 1 has a length of about 15 cm and is manufactured from ceramics, metal and plastic, for example. The injector 1 comprises a nozzle chamber 3, which is connected to a high-pressure reservoir via a fuel line (not shown here). The injector 1 shown in FIG. 1 is one of a plurality of injectors, which are each connected to the same high-pressure reservoir by fuel lines in a common rail system. At the bottom end of the injector 1, said injector has an injection opening 4, through which fuel, e.g. diesel fuel, can be injected from the nozzle chamber 3 into the combustion chamber.

Arranged in the nozzle chamber 3 is a nozzle needle 5, which is manufactured from metal and by means of which the injection opening 4 can be opened and closed. The nozzle needle 5 forms a closure element. The injection opening 4 is round and has a diameter of 0.4 mm. When the nozzle needle 5 is in an opened position, in which it exposes the injection opening 4, fuel under high pressure is injected into the combustion chamber from the nozzle chamber 3. In a closed position of the nozzle needle 5, in which the nozzle needle 5 closes the injection opening 4, injection of fuel into the combustion chamber is prevented.

The nozzle needle 5 is controlled by means of a closing spring 6 arranged in the upper section of the nozzle chamber 3 and by means of a piezo actuator 7, which actuates the nozzle needle 5 directly and is connected electrically to the open- and closed-loop control unit. The open- and closed-loop control unit 2 is set up to supply the piezo actuator 7 with a control voltage or with a control current. Depending on an activation by the open- and closed-loop control unit 2, the piezo actuator 7 can change length and exert a force on the nozzle needle 5, wherein the force can be transmitted to the nozzle needle 5 via a pin (concealed in FIG. 1), via a bell 8 and via levers 9. Via the pin, the bell 8 and the levers 9, the piezo actuator 7 and the nozzle needle 5 are directly coupled mechanically. In other words, the piezo actuator 7 is in direct contact with the pin, the pin is in direct contact with the bell 8, the bell 8 is in direct contact with the levers 9, and the levers 9 are in direct contact with the nozzle needle 5. The pin, the bell 8 and the levers 9 are each solid bodies manufactured from metal.

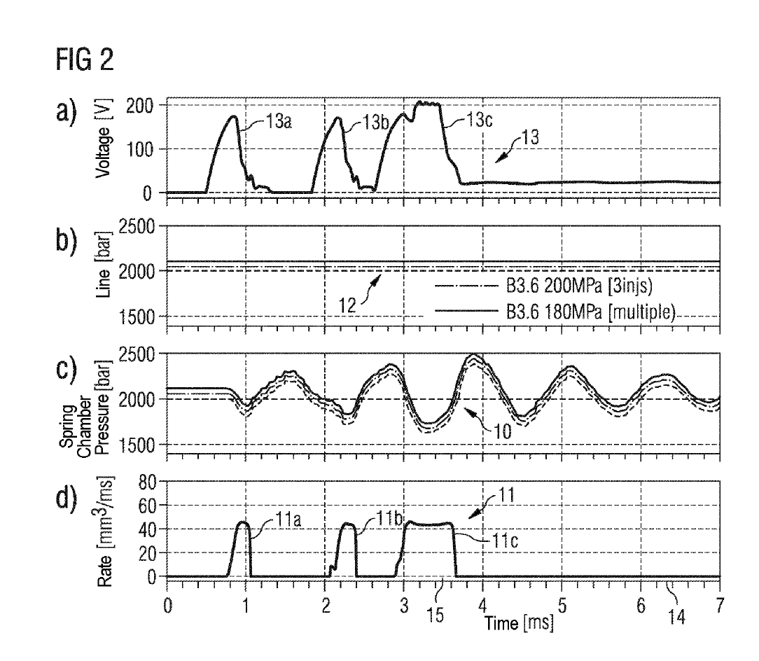

With the pin, the bell 8 and the levers 9 acting as intermediaries, a force exerted by the piezo actuator 7 is therefore transmitted directly to the nozzle needle 5. In other words, the piezo actuator 7 actuates the nozzle needle 5 directly. Conversely, a mechanical force exerted by the nozzle needle 5 acts in the same way directly on the piezo actuator 7. When the piezo actuator 7 is not being supplied with the control voltage or with the control current by the open- and closed-loop control unit 2, the closing spring 6 presses the nozzle needle 5 downward in FIG. 1, with the result that it closes the injection opening 4 against the nozzle chamber pressure 10 (see FIG. 2) in the nozzle chamber 3 and prevents injection.

Owing to the piezo actuator 7 being supplied with the control voltage or with the control current, the piezo actuator 7 is set up to exert a force on the nozzle needle 5 via the pin, the bell 8 and the levers 9, said force opposing a force exerted on the nozzle needle 5 by the closing spring 6. In other words, the piezo actuator 7 brings about the opening and closing of the injection opening 4 by means of the nozzle needle 5.

A method for detecting the nozzle chamber pressure in the injector 1 will be described below. The nozzle chamber pressure is caused primarily by a high-pressure pump which supplies the nozzle chamber 3 with fuel via the high-pressure reservoir and the fuel feed line. Typically, the pressure of the fuel in the nozzle chamber in the illustrative embodiment under consideration is between 1500 and 2500 bar. The pressure of the fuel in the nozzle chamber is at least 150 bar.

In the embodiment described here, the piezo actuator 7 which directly actuates the nozzle needle 5 comprises both an actuator and a sensor since the piezo actuator 7 can be operated both in the actuator mode and in the sensor mode. Fluctuations in the nozzle chamber pressure 10 in the nozzle chamber 3 are transmitted in the form of corresponding fluctuations in a force 16 to the piezo actuator 7 via the nozzle needle 5, the levers 9, the bell 8 and the pin and can be measured by or at the piezo actuator 7. Here, a force 16 transmitted to the piezo actuator 7 by means of the nozzle needle 5 or a change in said force represent a state of the nozzle needle 5 which depends on the nozzle chamber pressure 10. A position, a speed or an acceleration of the nozzle needle 5 are each also examples of states of the nozzle needle 5 which depend on the nozzle chamber pressure 10.

The force 16 and/or changes thereof which is/are transmitted to the piezo actuator 7 by the nozzle needle 5 induce an electric voltage 13 applied to the piezo actuator 7 by means of the piezoelectric effect (see FIG. 2), representing a measured variable that can be detected by or at the piezo actuator 7 in the form of at least one measured value. The voltage 13 depends on the state of the nozzle needle 5. The force 16 or a change thereof in or at the piezo actuator 7, which is transmitted to the piezo actuator 7 by the nozzle needle 5, likewise influences an electric charge stored in the piezo actuator and/or an electric charge which has flowed to the piezo actuator 7 and/or an electric current flowing through the piezo actuator 7 and/or an electric current which has flowed to the piezo actuator 7 and/or a capacitance of the piezo actuator 7 and/or energy stored in the piezo actuator 7 and/or energy which has flowed to the piezo actuator 7 and/or energy which has flowed out of the piezo actuator 7. The last-mentioned variables are also each measured variables which can be detected with or at the piezo actuator 7 in the form of at least one measured value and which each depend on the state of the nozzle needle 5. Changes in said measured variables with respect to time and/or variables derived mathematically from one or more of said measured variables are also intended to be taken as measured variables in the sense of the present invention. These too depend on the state of the nozzle needle 5.

In an alternative embodiment, the actuator can be provided by a magnetic actuator, for example. The sensor can be designed as a magnetic sensor or as a pressure-resistive sensor. For example, the magnetic actuator can be used to replace the piezo actuator 7, and the sensor can be used to replace or can be integrated into the bell 8.

FIG. 2 shows a simulation of a time characteristic of the nozzle chamber pressure 10 (FIG. 2c)) in the nozzle chamber 3 of the injector 1 and of an injection rate 11 (FIG. 2d)) at which fuel is injected into the combustion chamber from the nozzle chamber 3 of the injector 1 through the injection opening 4. The nozzle chamber pressure 10 is also referred to as spring chamber pressure. The time is shown on the abscissa 14 and, in the present case, comprises a time interval of 7 ms. The time characteristic of the nozzle chamber pressure 10 and of the injection rate 11 are determined using a line pressure 12 (FIG. 2b)), which is in each case assumed to be constant here, and using a voltage 13 (FIG. 2a)) applied to the piezo actuator 7. The line pressure 12 represents a pressure at a point ahead of the injector in the fuel feed line via which the nozzle chamber 3 is connected to the high-pressure reservoir and is supplied with fuel. The voltage 13 is a superposition of a control voltage and of a sensor voltage and is given by a time sequence of a plurality of voltage values, each representing measured values that can be detected by means of the piezo actuator 7 or at the piezo actuator 7.

In this case, the control voltage is the voltage with which the piezo actuator 7 is supplied in its capacity as an actuator by the open- and closed-loop control unit 2 for the purpose of controlling a movement of the nozzle needle 5 and hence of controlling the injection rate 11. In the example under consideration, the characteristic of the voltage 13 is decisively determined by the control voltage, which assumes a maximum value of about 200 V at a first point in time 15, at about 3.2 ms. The sensor voltage, in contrast, is the voltage which is induced in the piezo actuator 7 in its capacity as a sensor by the piezoelectric effect by way of the force 16 transmitted by the nozzle needle 5 to the piezo actuator 7 or a time derivative of said force (indicated in FIG. 1).

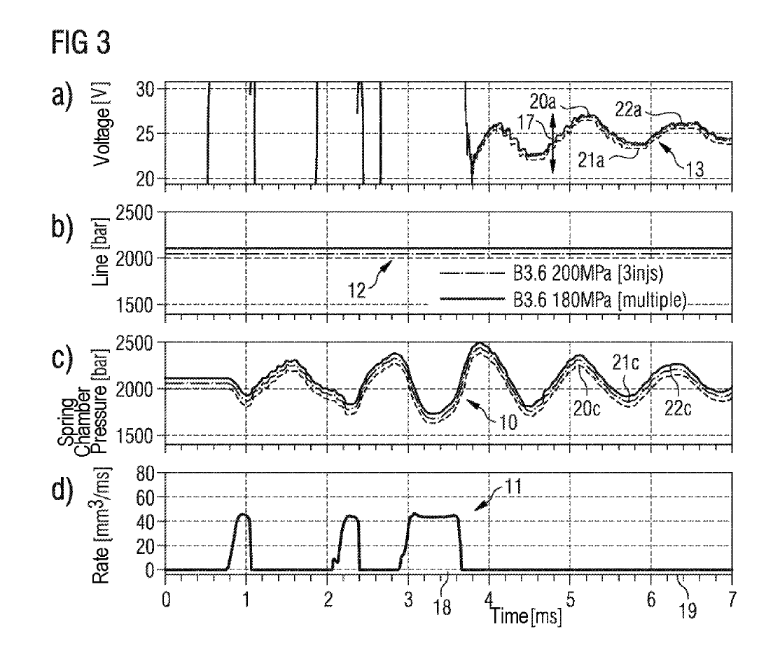

FIG. 3 shows the same time characteristics as FIG. 2, wherein repeated features are provided with identical reference signs. In FIG. 3, however, values of the voltage 13 are shown on an enlarged scale. This enables oscillations of the voltage 13 with an amplitude 17 of about 5 V due to fluctuations in the sensor voltage to be seen particularly clearly. In this connection, see the time interval between a second point in time 18 at about 3.8 ms and a third point in time 19 at 7 ms. The correlation between oscillations of the nozzle chamber pressure 10 and of the voltage 13 applied to the piezo actuator 7- and, at the same time, especially the proportion of the voltage 13 accounted for by the sensor voltage—said correlation advantageously being particularly pronounced in the method described here, can once again be seen from the time interval between the second point in time at about 3.8 ms and the third point in time 19 at 7 ms. Thus, for example, the maxima 20a and 22a of the voltage 13 coincide directly with the maxima 20c and 22c of the nozzle chamber pressure 10. The same applies to the minimum 21a of the voltage 13 and the minimum 21c of the nozzle chamber pressure 10. When the method described here is employed, oscillations of the nozzle chamber pressure 10 can therefore be detected with particularly high accuracy by means of the piezo actuator 7.

The control voltage and the sensor voltage, which are superposed in the voltage 13, can be separated in the course of an evaluation of the measured values by the subsequent use of a frequency filter, for example. In other words, a frequency filter can be used in the evaluation of the measured values. This can be a high pass filter, a low pass filter or a band pass filter. This is because the pressure oscillations in the nozzle chamber 3 which are to be detected in the method described here occur preferentially in one pressure wave frequency range. This pressure wave frequency range can depend on a geometry of the nozzle chamber 3, on a density, a temperature or a viscosity of the fuel, on the injection rate, on a mean nozzle chamber pressure or on a geometry of the fuel feed line into the injector 1.

In the present case, an output stage of the piezo actuator 7 is preferably operated with high impedance in the sensor mode for the purpose of determining the measured values of the voltage. For this purpose, the output stage is not short-circuited, and therefore the piezo actuator 7 is operated at zero current. In this way, a voltage drop across the piezo actuator 7 caused by oscillations of the nozzle chamber pressure 10 can be increased and determined with higher accuracy.

In FIG. 2, it can be clearly seen that pulses 13a, 13b and 13c applied to the piezo actuator 7 in the actuator mode of the piezo actuator 7 each bring about injections 11a, 11b and 11c in that, owing to the pulses 13a, 13b and 13c, the nozzle needle 5 is in each case moved out of a position in which it closes the injection opening 4 into a position in which it exposes the injection opening 4. A movement of the nozzle needle 5 back into the position in which it closes the injection opening 4 is brought about by the closing spring 6. Shoulders on right-hand flanks of the pulses 13a, 13b and 13c arise from the fact that the force 16 which the nozzle needle 5 transmits to the piezo actuator 7 and which induces a positive sensor voltage in said actuator rises briefly when the nozzle needle 6 strikes the injection opening 4 during the closure of the nozzle chamber 3. It can likewise be seen that the nozzle chamber pressure 10 sags by a few hundred bar in each case at the onset of the injections 11a, 11b and 11c. The opening and closing of the nozzle needle 5 causes the oscillations of the nozzle chamber pressure 10 which are shown in FIG. 2c). After the last injection 11c to occur, the oscillations of the nozzle chamber pressure 10 decay slowly. In this connection, see the nozzle chamber pressure 10 beyond about 4 ms.

From FIGS. 2 and 3, it can be seen that the time sequence of measured values which form the voltage 13 applied to the piezo actuator 7 can be detected at any point in time. For example, a measured value can be detected between two injection processes, during a charging phase of the piezo actuator, during a holding phase of the piezo actuator or during a discharge phase of the piezo actuator. In this case, let an injection process extend over a time interval within which the injection rate 11 exceeds a minimum value, e.g. 2 mm/ms. The pulses 11a, 11b and 11c of the injection rate 11 which are shown in FIG. 2d) each represent injection processes.

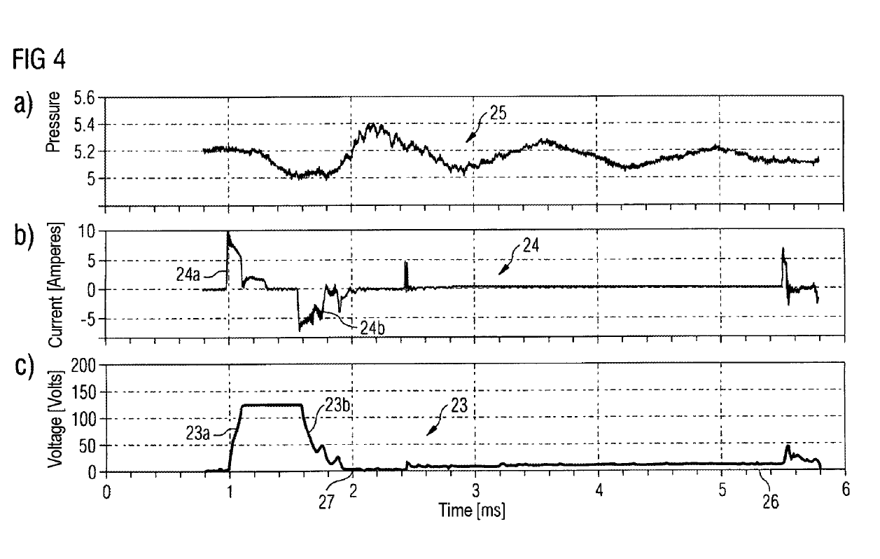

FIG. 4 shows a time characteristic of an actuator voltage 23 measured at the piezo actuator 7 (FIG. 4c)), of a control current 24 (FIG. 4b)) and of a line pressure 25 (FIG. 4a)), wherein the line pressure 25 has been determined immediately ahead of the injector 1. The line pressure 25 thus approximately represents the nozzle chamber pressure in the nozzle chamber 3 of the injector. Once again, the time in a time interval with a length of about 6 ms is plotted on an abscissa 26. It can be seen that a rising flank 23a and a falling flank 23b of a pulse of the actuator voltage 23 are associated with a positive charge current 24a flowing to the piezo actuator 7 and with a negative charge current 24b flowing away from the piezo actuator, respectively. A maximum value of the actuator voltage 23 is about 120 V. The control current 24 assumes values between −6 A and +10 A.

The pulse of the actuator voltage 23 moves the nozzle needle 5 into a position in which it exposes the injection opening 4 and hence it brings about an injection. At a fourth point in time 27 at 2 ms, the injection is complete. Owing to the injection process, a pressure wave propagates in the nozzle chamber 3, with the result that the line pressure 25 fluctuates with an amplitude of about 400 bar around a mean line pressure of about 2000 bar. Since no further injection is performed, the pressure wave is noticeably attenuated as the time lengthens.

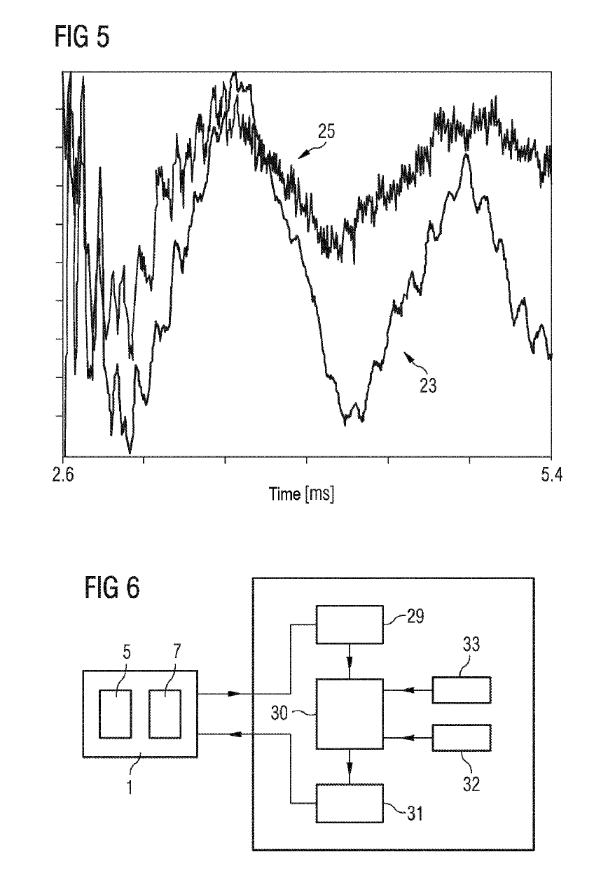

FIG. 5 shows the actuator voltage 23 and the line pressure 25 from FIG. 4 in a time interval between 2.6 ms and 5.4 ms on an enlarged scale. Once again, repeated features are provided with identical reference signs. A clear correlation can be seen between the line pressure 25 and the actuator voltage 23. After the pulse of the actuator voltage 23 dies out at the fourth point in time 27 (see FIG. 4) at 1 ms, fluctuations in the actuator voltage 23 with respect to time are attributable primarily to the pressure fluctuations in the nozzle chamber 3 of the injector 1. The measurement shown in FIGS. 4 and 5, particularly in the enlarged illustration in FIG. 5, thus illustrates that fluctuations in the nozzle chamber pressure with respect to time can be detected with high precision with the method described above and with the piezo actuator 7 as a sensor.

In FIG. 6, the injection system 100 comprising the injector 1 and the open- and closed-loop control unit 2 is shown schematically in a block structure. This block structure is intended to show how a deviation in a nozzle chamber pressure measured by means of the piezo actuator 7 from a predefined value is first of all determined by means of the open- and closed-loop control unit 2. In the text which follows, the predefined value is also referred to as the setpoint. In this case, the nozzle chamber pressure can, for example, be determined from the measured actuator voltage 23 shown in FIG. 3. Based on the deviation of a measured pressure value from the setpoint, a correction of an activation of the injector 1, in particular of the piezo actuator 7 which directly actuates the nozzle needle 5, can then be performed during a subsequent injection. In this way, it is possible to compensate the inherent pressure fluctuations which occur in the nozzle chamber 3 of the injector 1. If an engine includes further injectors in addition to injector 1, a corresponding compensation of the nozzle chamber pressure can be performed for each of these injectors individually.

The open- and closed-loop control unit 2 comprises a fast A/D converter 29, an adaptation function 30 implemented in a microcontroller, and an electronic closed-loop control unit 31. A feedforward compensation unit 32 makes available further injector and engine parameters to the adaptation function 30. Setpoints 33 for the pressure in the nozzle chamber 3 during an injection process or between successive injection processes are likewise shown schematically.

During a measurement with the piezo actuator 7, a plurality of measured values, e.g. the characteristic of the actuator voltage 23 shown in FIG. 3, is transferred to the A/D converter 29. In the present case, a sampling rate of the actuator voltage 23 is 10 kHz. By means of the adaptation function 30, the measured voltage values are first of all converted into corresponding pressure values of the nozzle chamber pressure, which are referred to below as measured pressure values. Conversion is performed individually for each of the injectors of the engine, with recourse being had to a calibrating measurement performed at an earlier point in time The deviation from the corresponding setpoint 33 is then determined for each of the measured pressure values. In the determination of the deviation, the further injector and engine parameters are detected for each of the measured pressure values by means of corresponding measuring devices and are transferred to the feedforward compensation unit 32, from where they are made available to the adaptation function 30.

The additional injector and engine parameters comprise an angular position of a piston associated with the injector 1 at the point in time of a measurement of the respective measured pressure value, an engine speed, a number of injections per piston cycle, a temperature of the injector and a pumping rate of the high-pressure pump. The further injector and engine parameters also comprise parameters which are invariable but are different for each of the injectors, e.g. a geometry of a fuel feed line into the respective injector or a distance between the respective injector and the high-pressure pump. Characteristics of the fuel, such as fuel density or fuel viscosity, can likewise be included in the further injector and engine parameters. The setpoints 33 are each determined for each individual injector in accordance with one or more of the further injector and engine parameters. For example, the setpoints 33 are given by a system pressure determined in the high-pressure reservoir.

The subsequent correction of the activation of the injector 1, which is intended to stand for corresponding corrections of an activation of the further injectors as well, for example, is then performed individually for the injector 1 and each of the further injectors in accordance with injector-specific values of the corresponding further injector and engine parameters. The correction, determined by the adaptation function 30, of the activation of the injector 1 is performed in accordance with the deviation of the measured pressure value from the setpoint 33 and from one or more of the injector and engine parameters. A correction value comprises a change in the injection duration and/or in an injection point and/or in a deflection of the nozzle needle 5 and/or in a time characteristic of the deflection of the nozzle needle 5 during a subsequent injection process. The correction value can also comprise a change in the system pressure in the high-pressure reservoir. In principle, it is conceivable for an adaptation of the injection duration to be performed while the injection process is still running, for example. The correction value is transferred by the adaptation function 30 to the closed-loop control unit 31, by means of which the activation of the piezo actuator 1 is corrected accordingly.

What is claimed is:

1. A method for analyzing a nozzle chamber pressure in an injector comprising a closure element for opening and closing an injection opening, and a piezo actuator configured to actuate the closure element, the method comprising:
using the piezo actuator to detect a measured value of a measured variable that is influenced by a state of the closure element, and
automatically determining a pressure value of the nozzle chamber pressure in the injector based on the measured value of the measured variable.

2. (canceled)

3. The method of claim 1, wherein the measured variable is selected from the group consisting of:
an electric voltage applied to the piezo actuator,
an electric charge stored in the piezo actuator,
an electric charge that has flowed to the piezo actuator,
an electric current flowing through the piezo actuator,
an electric charge that has flowed to the piezo actuator,
a capacitance of the piezo actuator,
energy stored in the piezo actuator, and
energy that has flowed to or from the piezo actuator.

4. The method of claim 1, wherein an output stage of the piezo actuator is operated with high impedance to detect the measured value.

5. The method of claim 1, wherein the measured value is detected during a charging phase, during a holding phase, or during a discharge phase of the piezo actuator.

6. The method of claim 1, wherein the state of the closure element is selected from the group consisting of a position of the closing element, a speed of the closing element, an acceleration of the closing element, or a force transmitted to the piezo actuator by the closure element.

7. The method of claim 1, further comprising detecting an angular position of a piston of a cylinder associated with the injector when determining the pressure value of the nozzle chamber pressure.

8. The method of claim 1, wherein the predefined value corresponds to a system pressure detected in a high-pressure reservoir or demanded by a control unit based on an engine state.

9. The method of claim 1, comprising:
determining a deviation of the determined pressure value from a predefined value, and
performing a correction of an activation of the injector based on the determined deviation of the determined pressure value from the predefined value.

10. The method of claim 9, wherein the correction comprises at least one of a change in an injection time, a change in an injection point, a change in a deflection of the closure element, and a change in a time characteristic of the deflection of the closure element during an injection process.

11. The method of claim 9, wherein the correction is performed based on an angular position of a piston of a cylinder associated with the injector, based on an engine state, based on a temperature of the injector, or based on a geometry of a fuel feed to the injector.

12. An injection system comprising:
at least one injector comprising:
a closure element for opening and closing an injection opening,
at least one actuator configured to:
(a) directly actuate the closure element, and
(b) detect a measured value of a measured variable that is influenced by a state of the closure element that depends on a nozzle chamber pressure in the injector, and
an open- and closed-loop control unit programmed to:
use the at least one piezo actuator to detect the measured value of the measured variable that is influenced by the state of the closure element, and
automatically determine a pressure value of the nozzle chamber pressure in the injector based on the measured value of the measured variable.

13. The injection system of claim 12, wherein the open- and closed-loop control unit is further programmed to:
determine a deviation of the determined pressure value from a predefined value, and
perform a correction of an activation of the at least one injector based on the determined deviation of the determined pressure value from the predefined value.
